(19) United States
(12) Patent Application Publication
(10) Pub. No.: US 2025/0031061 A1
(43) Pub. Date: Jan. 23, 2025

(54) LAYER 3 (L3) MEASUREMENT ASSISTED GROUP-BASED BEAM REPORTING (GBBR)

(71) Applicant: Apple Inc., Cupertino, CA (US)

(72) Inventors: Xiang CHEN, Campbell, CA (US); Yang TANG, San Jose, CA (US); Qiming LI, Beijing (CN); Jie CUI, San Jose, CA (US); Manasa RAGHAVAN, Sunnyvale, CA (US); Konstantinos SARRIGEORGIDIS, Los Gatos, CA (US)

(73) Assignee: Apple Inc., Cupertino, CA (US)

(21) Appl. No.: 18/668,587

(22) Filed: May 20, 2024

Related U.S. Application Data
(60) Provisional application No. 63/527,764, filed on Jul. 19, 2023.

(51) Int. Cl. H04W 16/28; H04B 7/06; H04L 5/00; H04W 24/10

(52) U.S. Cl. CPC H04W 16/28; H04B 7/06968; H04L 5/0051; H04W 24/10

(57) ABSTRACT

Embodiments are disclosed for enhanced layer 3 (L3) measurement reporting that supports L3 measurement assisted group-based beam reporting (GBBR). Some embodiments include a user equipment (UE) that can receive a first reference signal from a network at a first angle of arrival (AoA), and receive a second reference signal from the network at a second AoA. The UE can perform L3 measurements on the first reference signal and the second reference signal, and generate and transmit to the network, an enhanced L3 measurement report that includes L3 measurements as well as: a corresponding identity of an antenna panel of the UE; bits that correlate an antenna panel with a respective L3 measurements, or an implication that the L3 measurements in the enhanced L3 measurement report correspond to different antenna panels. The UE can receive simultaneous downlink transmissions from the network that are based on the enhanced L3 measurement report.

### CROSS REFERENCE TO RELATED APPLICATIONS

This application claims the benefit of U.S. Provisional Application No. 63/527,764, filed on Jul. 19, 2023, which is incorporated herein by reference in its entirety.

### BACKGROUND

### Field

The embodiments relate generally to wireless devices that access a wireless communication system.

### Related Art

The embodiments relate to multiple signal transmissions and multiple signal receptions in a wireless network.

### SUMMARY

Some embodiments include an apparatus, method, and/or computer program product for layer 3 (L3) measurement assisted group-based beam reporting (GBBR). Some embodiments include a user equipment (UE) that can receive a first reference signal from a network at a first angle of arrival (AoA), receive a second reference signal from the network at a second AoA, and perform layer 3 (L3) measurements on the first reference signal and the second reference signal. The UE can generate and transmit to the network, an enhanced L3 measurement report including the first L3 measurements corresponding to the first reference signal and the second L3 measurements corresponding to the second reference signal. The UE can receive simultaneous downlink transmissions from the network that are based on the enhanced L3 measurement report.

In some embodiments, the first L3 measurements include an antenna panel identity (ID), N, where N is an integer corresponding to a first antenna panel of a plurality of antenna panels of the UE that received the first reference signal. In some examples, the first L3 measurements includes a bit, where a value of the bit corresponds to a first antenna panel of the UE that receives the first reference signal. In some examples, a presence of the first L3 measurements and the second L3 measurements in the enhanced L3 measurement report implies that the first L3 measurements and the second L3 measurements are measured at different antenna panels of the UE.

In some embodiments, a downlink transmission of the simultaneous downlink transmissions correspond to a different Quasi-Colocation (QCL) D reference signal than other downlink transmissions of the simultaneous downlink transmissions. To receive the simultaneous downlink transmissions, the UE can receive, via a first antenna panel, a first channel measurement resource (CMR) set based on the first L3 measurements, and receive simultaneously, via a second antenna panel, a second CMR set based on the second L3 measurements. The UE can perform layer 1 (L1) measurements on the first CMR set and the second CMR set, and generate and transmit to the network, a group-based beam report including the layer 1 measurements. The UE can receive on a single component carrier, two simultaneous downlink transmissions based at least on the first CMR set and the second CMR set, where the second simultaneous downlink transmissions can include different payloads.

The UE can receive a third reference signal from the network at a third AoA, where the first reference signal and the third reference signal are received on a same antenna panel. The UE can compare L3 measurements of the first reference signal with L3 measurements of the third reference signal, where the first L3 measurements are based at least on the comparison. In some examples, first reference signal is received via a rough beam (whose beamwidth is wider and beamforming gain is smaller), and a downlink transmission of the simultaneous downlink transmissions is received via a fine beam (whose beamwidth is narrower and beamforming gain is larger).

Some embodiments include a network baseband unit (BBU) that can transmit, or cause to transmit, a first reference signal at a first angle of arrival (AoA), and transmit, or cause to transmit, a second reference signal at a second AoA. The network BBU can receive from a UE, an enhanced L3 measurement report including L3 measurements corresponding to the first reference signal, and second L3 measurements corresponding to the second reference signal. The network BBU can transmit, or cause to transmit, simultaneously, a first downlink transmission associated with the first L3 measurements, and a second downlink transmission associated with the second L3 measurements. In some examples, the first downlink transmission corresponds to a different Quasi-Colocation (QCL) D reference signal (RS) than the second downlink transmission.

In some examples, the BBU can select and transmit or cause to transmit a first channel measurement resource (CMR) set based on the first L3 measurements, and select and transmit or cause to transmit a second CMR set based on the second L3 measurement. The network BBU can receive a group-based beam report including layer 1 measurements, where the layer 1 measurements are based at least on the first CMR set and the second CMR set. The network BBU can transmit simultaneously on a single component carrier, the first downlink transmission based at least on the first CMR set and the second downlink transmission based at least on the second CMR set.

In some embodiments, the first L3 measurements include an antenna panel ID, N, where N is an integer, wherein N corresponds to an antenna panel of the UE associated with the first L3 measurements. In some examples, the first L3 measurements includes one or more bits, where a value of the one or more bits corresponds to an antenna panel of the UE associated with the first L3 measurements. In some examples, the network BBU can transmit a signal for enabling or disabling enhanced L3 measurement reporting that supports L3 measurement assisted group-based beam reporting (GBBR).

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for layer 3 (L3) measurement assisted group-based beam reporting (GBBR), in accordance with some embodiments of the disclosure.

FIG. 2 illustrates a block diagram of an example wireless system supporting L3 measurement assisted GBBR, according to some embodiments of the disclosure.

FIG. 3 illustrates an example with rough beam measurements for L3 measurement assisted GBBR, according to some embodiments of the disclosure.

FIG. 4 illustrates an example of L3 measurement assisted GBBR, according to some embodiments of the disclosure.

FIG. 5 illustrates an example method for a user equipment (UE) supporting L3 measurement assisted GBBR, according to some embodiments of the disclosure.

FIG. 6 illustrates an example method for a network (e.g., a baseband unit (BBU) and/or a base station (BS)) supporting L3 measurement assisted GBBR, according to some embodiments of the disclosure.

FIG. 7 is an example computer system for implementing some embodiments or portion(s) thereof.

FIG. 8 illustrates an example system supporting GBBR, in accordance with some embodiments of the disclosure.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments include an apparatus, method, and/or computer program product for layer 3 (L3) measurement assisted group-based beam reporting (GBBR). A communication network that includes a radio access network can signal to enable and/or disable L3 measurement assisted GBBR. L3 measurement assisted GBBR can improve the chances of a user equipment (UE) reporting pairs of beams (e.g., from different directions) from which simultaneous downlink (DL) reception are possible while saving battery power, compared to GBBR based on only layer 1 (L1) measurements. Some embodiments include transmitting an enhanced L3 measurement report that includes an indication that a L3 measurement correspond to an antenna panel of the UE.

Measurements can be generated and reported by the UE to a network (e.g., via a transmission and reception point (TRP) to a baseband unit, and/or via a base station (BS)) that include L1 and/or L3 measurements. L1 measurements can be used for procedures that react with minimal delay like beam management procedures. UE can transmit SS-RSRP measurements at L1 according to the Channel State Information (CSI) reporting configuration(s) to the network. L1 measurements can correspond to beam measurements (e.g., fine beam measurements.) L3 measurements are useful for radio resource management decisions that utilize a long term view of channel conditions such as handover procedures. L3 measurements can correspond to cell measurements (e.g., rough beam measurements.) For example, a UE can provide Synchronization Signal-Reference Signal Received Power (SS-RSRP) measurements at L3 to the network in a Radio Resource Control (RRC) message. In some examples, L3 measurements can be derived from L1 measurements by applying L3 filtering.

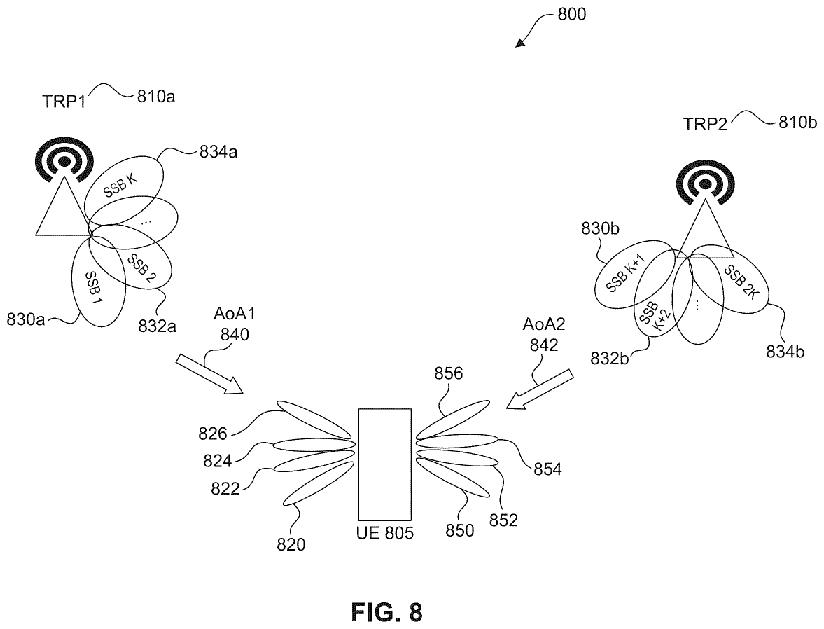

FIG. 8 illustrates example system 800 supporting GBBR, in accordance with some embodiments of the disclosure. System 800 can include UE 805 that can receive reference signals at different angle of arrivals (AoAs) (e.g., AoA1 840 and AoA2 842) from different TRPs, TRP1 810a and TRP2 810b that belong to the same network. UE 805 can utilize L1 measurements corresponding to fine beams 820, 822, 824, and 826 of a first panel of UE 805 to receive and measure reference signals (e.g., Synchronization Signal/Physical Broadcast Channel (PBCH) block (SSB) 1 830a, SSB 2 832a, and so on to SSB K 834a where K is an integer from TRP1 810a.) For each fine beam (e.g., fine beams 820, 822, 824, and 826), UE 805 collects L1 measurements such as L1 Reference Signal Received Power (RSRP). In some examples, the reference signals from the communication network can be CSI-reference signals (e.g., L1 RSRP can be transmitted with CSI measurements to the network.) UE 805 can utilize L1 fine beams 850, 852, 854, and 856 of a second panel of UE 805 to receive reference signals (e.g., SSB K+1 830b, SSB K+2 832b, and so on to SSB 2K 834b from TRP2 810b.) For each fine beam (e.g., fine beams 850, 852, 854, and 856), UE 805 collects L1 measurements such as L1 RSRP based on the SSBs received. UE 805 can determine that UE 805 can receive simultaneous downlink transmissions at an AoA 1 840 from TRP1 810a and AoA 2 842 from TRP2 810b. Thus, UE 805 can transmit to the network via TRP1 810a or TRP2 810b, GBBR informing the network of L1 measurements corresponding to reference signals received by UE 805 from different directions (e.g., AoA 1 840 from TRP1 810a or SSB2, and AoA 2 842 from TRP2 810b or SSB K+2.)

The problem with the GBBR is that UE 805 takes time to receive the reference signals via the fine beams with narrow angles of reception. Further, GBBR is based on L1 measurements which utilize UE 805 resources (e.g., power) to generate and transmit L1 measurements resulting in high battery usage. In addition, the network utilizes resources in transmitting the various reference signals SSB 1 830a, SSB K+1 830b, and so on in many directions to enable UE 805 to receive and detect the reference signals via the fine beams.

Some embodiments include L3 measurement assisted GBBR that enable a UE to receive reference signals via rough beams (e.g., wide beams) with wider angles of reception than the fine beams, and perform measurements at L3, since L3 measurement is needed for mobility purposes and for time/frequency synchronization purposes. In addition, the UE can transmit to the network an enhanced L3 measurement report that includes L3 measurements corresponding to various antennas of the UE. Based on the enhanced L3 measurement report(s), the network can transmit reference signals (e.g., channel measurement resource (CMR) sets) in targeted directions (e.g., according to AoA) to the UE. The UE can simultaneously receive a CMR set at a corresponding antenna panel via a fine beam, and another CMR set at a different antenna panel via another fine beam. The UE can perform L1 measurements based on the CMR sets and transmit L1 measurements to the network. Thus, the L3 measurement assisted GBBR embodiments enable the UE to utilize less resources (e.g., use less battery resources, power, time) compared to GBBR utilizing only fine beam measurements at L1.

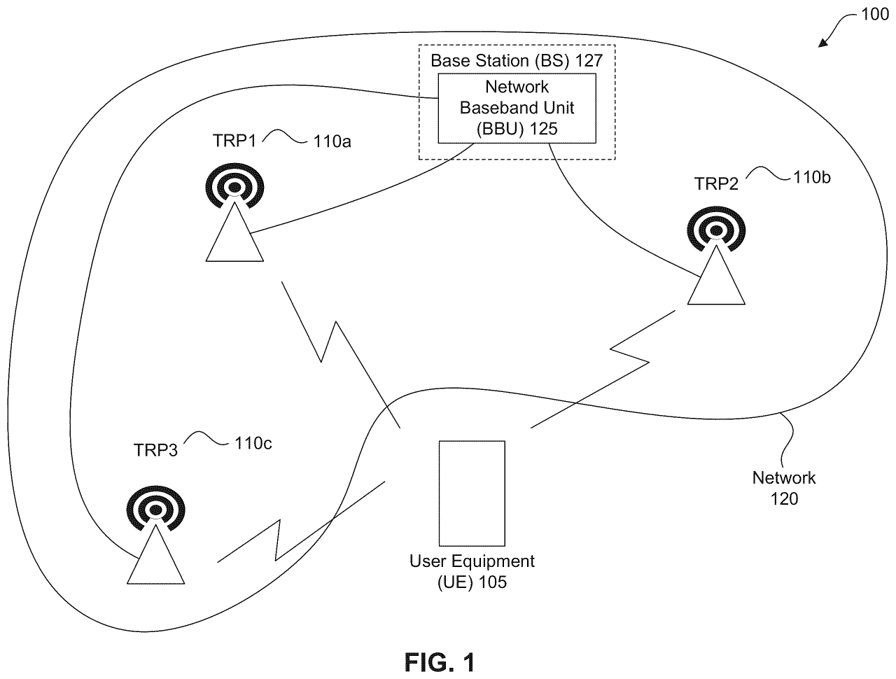

FIG. 1 illustrates example system 100 for L3 measurement assisted GBBR, in accordance with some embodiments of the disclosure. System 100 can include UE 105 that can communicate with network 120, where UE 105 and network 120 can support L3 measurement assisted GBBR. System 100 can utilize wireless technologies including but not limited to 3rd Generation Partnership Project (3GPP) standards, Fifth Generation (5G), Sixth Generation (6G), cellular technologies, and/or new radio (NR). UE 105 and network 120 can operate in various frequency ranges including but not limited to NR Frequency Range 1 (FR1), and/or NR Frequency Range 2 (FR2) including FR2-1 (e.g., 24 GHz-52.6 GHZ), FR2-2 (e.g., 57 GHz-71 GHz range.) UE 105 can be an electronic device including but not limited to a computing device, a cellular phone, a smart phone, a tablet, a personal digital assistant (PDA), a laptop, wearable computer devices, or pagers. UE 105 can communicate with network 120 via a radio access network (RAN) that can include TRPs (e.g., TRP1 110a, TRP2 110b, TRP3 110c.) A TRP can be, for example, a radio head that transmits and receives signals to and from UE 105 and network baseband unit (BBU) 125, where UE 105 and network BBU 125 perform signal processing (e.g., baseband unit functions.) In some examples, the RAN includes one or more base stations (BSs) (not shown) instead of or in combination with one or more TRPs, where a BS can perform signal processing. In some examples, a BSs (e.g., BS 127) can include functions of a TRP and network BBU 125.

In some embodiments, network 120 can transmit a signal to UE 105 enabling or disabling L3 measurement assisted GBBR. UE 105 may be capable of receiving multiple simultaneous downlink transmissions (e.g., a multi-RX capable UE) from different directions with different Quasi-Colocation (QCL) Type D reference signals on a single component carrier. For example, UE 105 can receive two or more signals with different angle of arrivals (AoAs). When UE 105 is a multi-RX capable UE, network 120 can transmit a signal (e.g., mode 1) enabling L3 measurement assisted GBBR. The signal may be transmitted via radio resource control (RRC) signaling, media access control (MAC) control element (CE) signaling, and/or downlink control information (DCI) signaling. In some examples, when UE 105 is a multi-RX capable UE, network 120 can transmit a signal (e.g., mode 2) disabling (e.g., not enabling) L3 measurement assisted GBBR. The signal can be transmitted via RRC signaling, MAC CE signaling, and/or DCI signaling.

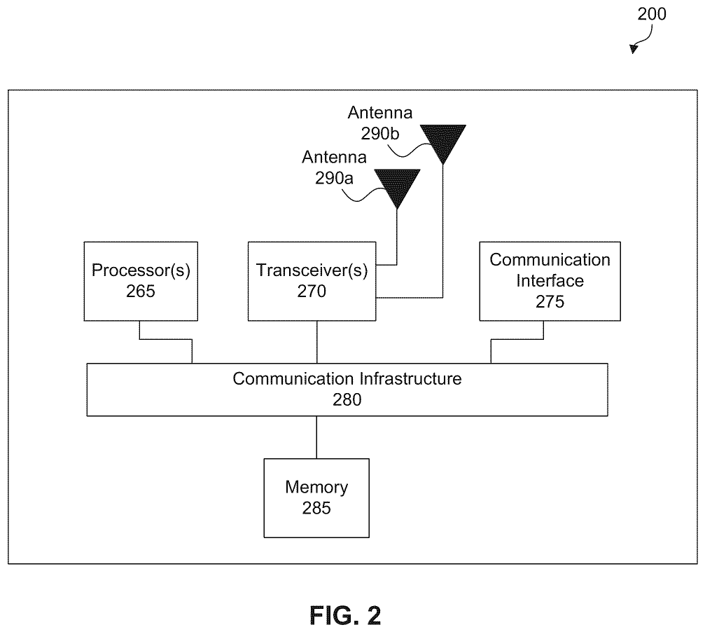

FIG. 2 illustrates a block diagram of example wireless system 200 supporting L3 measurement assisted GBBR, according to some embodiments of the disclosure. For explanation purposes and not a limitation, FIG. 2 may be described with reference to elements from FIG. 1. For example, system 200 may be any of the electronic devices of system 100 including but not limited to UE 105, TRP1 110a, TRP2 110b, TRP3 110c, network BBU 125, or BS 127.

System 200 includes one or more processors 265, transceiver(s) 270, communication interface 275, communication infrastructure 280, memory 285, and antenna 290. Memory 285 may include random access memory (RAM) and/or cache, and may include control logic (e.g., computer instructions) and/or data. One or more processors 265 can execute the instructions stored in memory 285 to perform operations enabling system 200 to transmit and receive wireless communications, including the operations for performing L3 measurement assisted GBBR described herein. In some embodiments, one or more processors 265 can be “hard coded” to perform the functions herein. Communication interface 275 allows system 200 to communicate with other devices that may be wired and/or wireless. Communication infrastructure 280 may be a bus. Transceiver(s) 270 transmits and receives wireless communications signals including wireless communications supporting L3 measurement assisted GBBR according to some embodiments, and may be coupled to one or more antennas 290 (e.g., 290a, 290b). Antennas 290a and/or 290b may include one or more antennas that may be the same or different types. In some embodiments, transceiver 700 can be a hybrid wireless transceiver that includes transceiver 270a coupled to antenna 290a and coupled to transceiver 270b. Transceiver 270b can be coupled to antenna 290b.

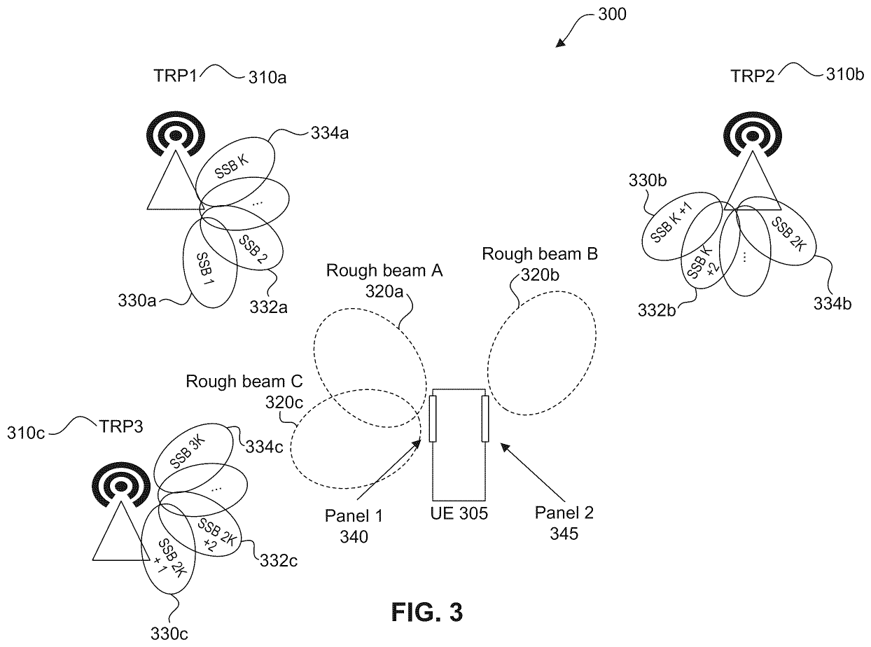

FIG. 3 illustrates example 300 with rough beam measurements for L3 measurement assisted GBBR, according to some embodiments of the disclosure. For explanation purposes and not a limitation, FIG. 3 may be described with reference to elements from FIG. 1. For example, UE 305, TRP1 310a, TRP2 310b, TRP3 310c of FIG. 3 can be UE 105, TRP1 110a, TRP2 110b, TRP3 110c of FIG. 1. As with FIG. 1, the TRPs of FIG. 3 belong to the same network (e.g., network 120 not shown.) L3 measurement assisted GBBR begins with UE 305 achieving time/frequency synchronization with network 120 based on L3 measurements obtained from reference signals received by rough beams that have a wider angle of reception compared to fine beams. UE 305 can select L3 measurements corresponding to the strongest received reference signal at each antenna panel, and transmit an enhanced L3 measurement report to network 120. The L3 measurements in an enhanced L3 measurement report correspond to L3 measurements generated at different antenna panels of UE 305.

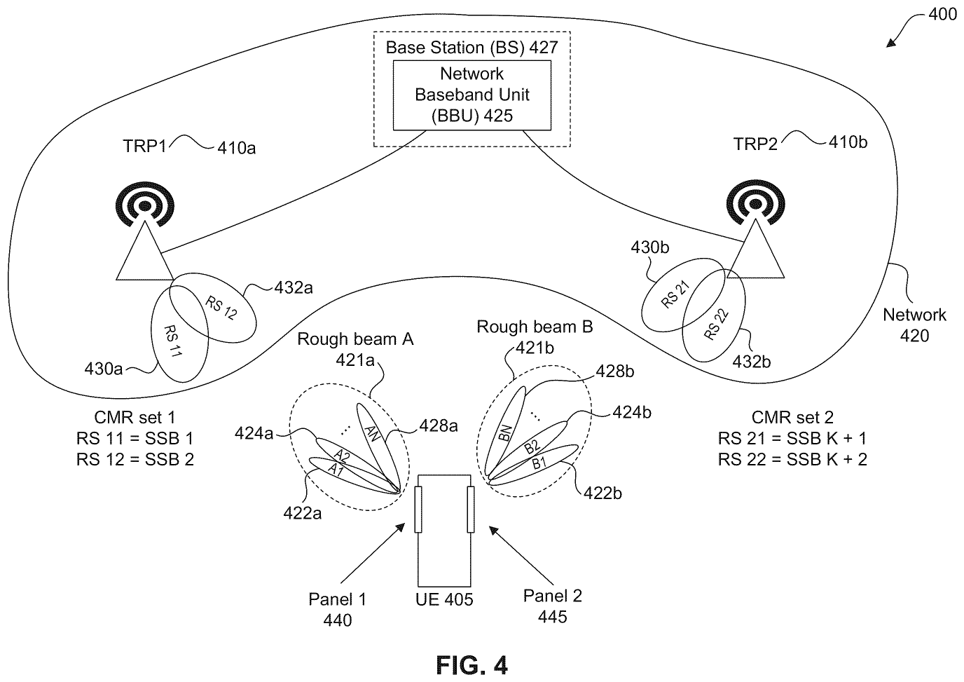

Once network 120 receives the L3 measurements and understands that directions from which UE 305 can receive simultaneous DL transmissions, network 120 can determine and transmit a targeted corresponding channel measurement resource (CMR) set of reference signals for each antenna panel of UE 305. UE 305 can receive and perform L1 measurements on the CMR set of reference signals at corresponding antenna panels via fine beams. UE 305 can transmit a GBBR report including the L1 measurements to network 120 that is described below in FIG. 4.

UE 305 can include more than one antenna panel. For explanation purposes and not a limitation, two antenna panels are shown as panel 1 340 and panel 2 345. UE 305 can receive reference signals (e.g., SSB 1 330a, SSB 2 332a, and so on to SSB K 334a where K is an integer) from TRP1 310a via rough beam A 320a of panel 1 340, where a rough beam has a wider angle of reception than a fine beam. UE 305 can also receive reference signals (e.g., SSB K+1 330b, SSB K+2 332b, and so on to SSB 2K 334b where K is an integer) from TRP2 310b via rough beam B 320b of panel 2 345. Further, UE 305 can receive reference signals (e.g., SSB 2K+1 330c, SSB 2K+2 332c, and so on to SSB 3K 334c where K is an integer) from TRP3 310c via rough beam C 320c of panel 1 340. As a multi-RX capable UE, UE 305 can simultaneously receive reference signals at each of panel 1 340 and panel 2 345. Thus, UE 305 can receive simultaneous downlink (DL) reference signals from TRP1 310a and TRP2 310b, or from TRP2 310b and TRP3 310c. But, UE 305 cannot receive simultaneous DL reference signals from TRP1 310a and TRP3 310c since they are received at the same antenna panel, panel 1 340.

To determine the different directions for receiving DL reference signals, UE 305 makes L3 measurements corresponding to each rough beam (e.g., rough beam A 320a, rough beam B 320b, and rough beam C 320c), that correspond to various antenna panels (e.g., panel 1 340 and panel 2 345.) Since rough beam A 320a and rough beam C 320c both correspond to panel 1 340, UE 305 can compare the L3 measurements of reference signals received via rough beam A 320a with L3 measurements of reference signals received via rough beam C 320c. UE 305 can choose to receive DL reference signals corresponding with the most favorable L3 measurements (e.g., L3 RSRP measurement.) For example, UE 305 can choose to receive reference signals via TRP1 310a corresponding to first L3 measurements associated with reference signals received by rough beam A 320a. UE 305 can also choose to receive reference signals via TRP2 310b corresponding to second L3 measurements associated with reference signals received by rough beam B 320b. For example, UE 305 can transmit the first L3 measurements and the second L3 measurements in an L3 measurement report to network 120.

The L3 measurements identify the TRP (or BS) from which the DL reference signal is received and from which L3 measurements are collected. In some embodiments, L3 measurements included in an enhanced L3 measurement report identify the antenna panels of a UE (e.g., UE 305.) For example, the L3 measurements (e.g., the first L3 measurements and the second L3 measurements) included in an enhanced L3 measurement report supporting L3 measurement assisted GBBR can be called enhanced L3 measurements. Some embodiments include different ways that UE 305 can indicate the antenna panel corresponding to L3 measurements: explicitly via an antenna panel identifier (ID), with a bit value that indicates an antenna panel of the total antenna panels or implicitly indicate that each L3 measurement set in an enhanced L3 measurement report corresponds to a different antenna panel of UE 305.

In some embodiments, UE 305 includes an ID of an antenna panel from which the L3 measurements are collected in the L3 measurement report. For example, the L3 measurement report can include first L3 measurements: (RSRP/RSR Quality (RSRQ)/RS-signal-to-noise and interference ratio (SINR), antenna panel ID), where the antenna panel ID can include values of {1, 2, 3, . . . , N} where N is an integer of the number of panels of UE 305. In example 300, the first L3 measurements are made based on reference signals received via rough beam A 320a can include: (RSRP/RSRQ/RS-SINR, N), where the value of the antenna panel ID, N, would include the values of {1, 2} to identify panel 1 340 or panel 2 345.

For example, UE 305 can attach an ID of the antenna panel used for the L3 measurement in an enhanced L3 measurement report. Assume the network receives the following enhanced L3 measurement report from the UE:

[RSRP for SSB 1, panel ID 1],
[RSRP for SSB 2, panel ID 1],
[RSRP for SSB 3, panel ID 1],
[RSRP for SSB 3K − 2, panel ID 1],
[RSRP for SSB 3K − 1, panel ID 1],
[RSRP for SSB 3K, panel ID 1],
[RSRP for SSB K + 1, panel ID 2],
[RSRP for SSB K + 2, panel ID 2],
[RSRP for SSB K + 3, panel ID 2].

The network now knows that UE 305 used the same panel, panel 1 340, to perform L3 measurements for TRP 1 310a and TRP3 310c. If the RSRP values for TRP1 310a, (e.g., RSRP for SSB 1/2/3, are higher than those for TRP3 310c, e.g., RSRP for SSB 3K-2/3K-1/3K, the network can choose to configure one CMR set for TRP1 310a and another CMR set for TRP2 310b.

In some embodiments, UE 305 can include a number of bits to indicate different panels rather than identifying a specific antenna panel ID. In example 300, there are two antenna panels, thus a single bit may be used in the first L3 measurements, (RSRP/RSRQ/RS-SINR, 0), where the bit value of ‘0’ corresponds to panel 1 340. Second L3 measurements, (RSRP/RSRQ/RS-SINR, 1), may include the bit value of ‘1’ corresponding to panel 2 345. If UE 305 included more antenna panels, then the number of bits in the L3 measurements can be increased accordingly.

For example, in an L3 measurement, UE uses a single bit to indicate different panels. Assume the network receives the following enhanced L3 measurement report from UE 305:

[RSRP for SSB 1, bit 0],
[RSRP for SSB 2, bit 0],
[RSRP for SSB 3, bit 0],
[RSRP for SSB 3K − 2, bit 0],
[RSRP for SSB 3K − 1, bit 0],
[RSRP for SSB 3K, bit 0],
[RSRP for SSB K + 1, bit 1],
[RSRP for SSB K + 2, bit 1],
[RSRP for SSB K + 3, bit 1].

The network now knows that UE 305 used the same panel to perform L3 measurements for TRP 1 310a and TRP3 310c (although the network does not know the exact panel ID). If the RSRP values for TRP1 310a, (e.g., RSRP for SSB 1/2/3, are higher than those for TRP3 310c, e.g., RSRP for SSB 3K-2/3K-1/3K, the network can choose to configure one CMR set for TRP1 310a and another CMR set for TRP2 310b.

In some embodiments, each set of L3 measurements implicitly indicates a different antenna panel of a UE. In example 300, UE 305 can transmit an enhanced L3 measurement report where the first L3 measurements (RSRP/RSRQ/RS-SINR) and the second L3 measurements (RSRP/RSRQ/RS-SINR) implicitly correspond to the different antenna panels: panel 1 340 and panel 2 345. In some examples, UE 305 skips some L3 measurements in the enhanced L3 measurement report. For example, when two or more L3 measurements are made at the same antenna panel, the highest L3 measurements (e.g., corresponding to the strongest reference signals received) can be selected. In example 300, UE 305 can skip the third L3 measurements corresponding to rough beam C 320c because both rough beam A 320a and rough beam C 320c correspond to panel 1 340. UE 305 can compare the first L3 measurements made from a reference signal received via rough beam A 320a with the third L3 measurements made from a reference signal received via rough beam C 320c and select, for example, first L3 measurements corresponding to TRP1 310a. Thus, UE 305 would not report the third L3 measurements corresponding to rough beam C 320c from TRP3 310c.

For example, UE 305 can skip some L3 measurements in the report, implicitly indicating the L3 measurements are done with different panels. In this case, if the RSRP values for TRP1 310a, e.g., RSRP for SSB 1/2/3, are higher than those for TRP3 310c, e.g., RSRP for SSB 3K-2/3K-1/3K, UE 305 will not report L3 measurement results for TRP3 310c. As a result, the network receives the following enhanced L3 measurement report from UE 305:

[RSRP for SSB 1],
[RSRP for SSB 2],
[RSRP for SSB 3],
[RSRP for SSB K + 1],
[RSRP for SSB K + 2],
[RSRP for SSB K + 3].

The network knows that UE 305 used different panels to perform L3 measurements for TRP 1 310a and TRP2 310b. The network can choose to configure one CMR set for TRP1 310a and another CMR set for TRP2 310b.

In an example, if L3 measurements made at an antenna panel are low (e.g., the received reference signal is a weak signal), then the UE can choose not to report the corresponding L3 measurements. In example 300, UE 305 may compare one or more L3 measurements against respective threshold values. Only when the respective threshold values are satisfied does UE 305 include those L3 measurements in the L3 measurement report. For example, if the first L3 measurements satisfy the corresponding threshold values, but the second L3 measurements do not satisfy the corresponding threshold values, UE 305 can also skip the reporting of the second L3 measurements and transmit the first L3 measurements (RSRP/RSRQ/RS-SINR). Thus, UE 305 would only receive DL transmissions from TRP1 310a via panel 1 340, even though UE 305 is capable of receiving multiple downlink signals simultaneously. In some examples, the respective threshold value(s) can be pre-defined as a value or a range of values. The respective threshold value(s) can be signaled from the network to UE 305 via RRC, MAC CE, or DCI signaling.

FIG. 4 illustrates an example of L3 measurement assisted GBBR, according to some embodiments of the disclosure. For explanation purposes and not a limitation, FIG. 4 may be described with reference to elements from FIGS. 1 and 3. For example, UE 405, TRP1 410a, TRP2 410b, panel 1 440 and panel 2 445 can be UE 305, TRP1 310a, TRP2 310b, panel 1 340, and panel 2 345 of FIG. 3. TRP1 410a and TRP2 410b belong to network 420 that includes network BBU 425 that can correspond to network 120 and network BBU 125 of FIG. 1.

UE 405 received reference signals via rough beam A 421a and rough beam B 421b, collected corresponding L3 measurements, and transmitted the L3 measurements in an enhanced L3 measurement report to network 420 via TRP1 410a or TRP2 410b. UE 405 can indicate via the L3 measurement reports explicitly or implicitly, the antenna panel or the number of antenna panels with which UE 405 can receive simultaneous DL transmissions (e.g., via explicit antenna panel ID, bit value that corresponds to different antenna panels, or implicitly link an L3 measurement set with a different antenna panel.)

Based on the enhanced L3 measurement report, network 420 determines refined CMR sets (e.g., a sufficient CMR set including less reference signals than GBBR without L3 measurement assistance) corresponding to the L3 measurements received. For example, network 420 determines that UE 405 can receive reference signals in certain directions such as SSB 1 (RS 12 432a) and SSB K+1 (RS 21 430b). In other words, network 420 can determine transmission configuration indicator (TCI) states associated with RS 12 432a and RS 21 430b received by UE 405 based on the L3 measurements in the enhanced L3 measurement report sent to network 420. The refined CMR sets improve the chances of UE 405 being able to report good beam pairs compared to GBBR that does not use L3 measurement assistance. For example, network BBU 425 may receive the L3 measurements corresponding to rough beam A 421a, and network BBU 425 can determine a refined CMR set 1 where reference signal (RS) 11=SSB 1 and RS 12-SSB 2. Note that refined CMR set 1 includes less reference signals compared to those transmitted by TRP1 310a of FIG. 3 or TRP1 810a of FIG. 8.

Network BBU 425 may receive the L3 measurements corresponding to rough beam B 421b, and network BBU 425 can determine refined CMR set 2 where reference signal (RS) 21=SSB K+1 and RS 22=SSB K+2. Note that refined CMR set 2 includes less reference signals compared to those transmitted by TRP2 310b of FIG. 3 or TRP2 810b of FIG. 8. In some embodiments, BS 427 can include a TRP function and the network BBU 425.

UE 405 may perform measurements at L1 on reference signals received via fine beams 422a, 424a, and so on to 428a corresponding to rough beam A 421a (e.g., within the angle of reception of rough beam A 421a) and panel 1 440. UE 405 may perform measurements at L1 on reference signals received via fine beams 422b, 424b, and so on to 428b corresponding to rough beam B 421b and panel 2 445. UE 405 transmits L1 measurement reports to network 420 via TRP1 410a or TRP2 410b for GBBR. Note that UE 405 performs L1 measurements on reference signals received over a narrower range via fine beams 422a, 424a, and so on to 428a compared to UE 805 that performs L1 measurements on reference signals received over a wider range (e.g., fine beams 820, 822, 824, and 826.) Thus, L3 measurement assisted GBBR embodiments using enhanced L3 measurement reports enable a narrower, more refined set of reference signals for CMR sets. Thus, UE 405 receiving and making L1 measurements on reference signals from the refined CMR sets via fine beams results in more succinct usage of resources (e.g., narrower range of fine beams that receive a refined CMR set) compared to GBBR based on L1 measurements alone, improving battery usage of UE 405.

Network 420 can then transmit data (e.g., via Physical Downlink Shared Channel (PDSCH)) on a single component carrier to UE 405 via simultaneous DL transmissions in different directions with different QCL Type D RSs via one beam from TRP1 410a and another beam from TRP2 410b according to the L1 RSRP measurements in the L3 measurement assisted GBBR embodiments. For example, the payload transmitted from TRP1 410a and received at panel 1 440 is different than the payload transmitted simultaneously from TRP2 410b and received at panel 2 445 to UE 405.

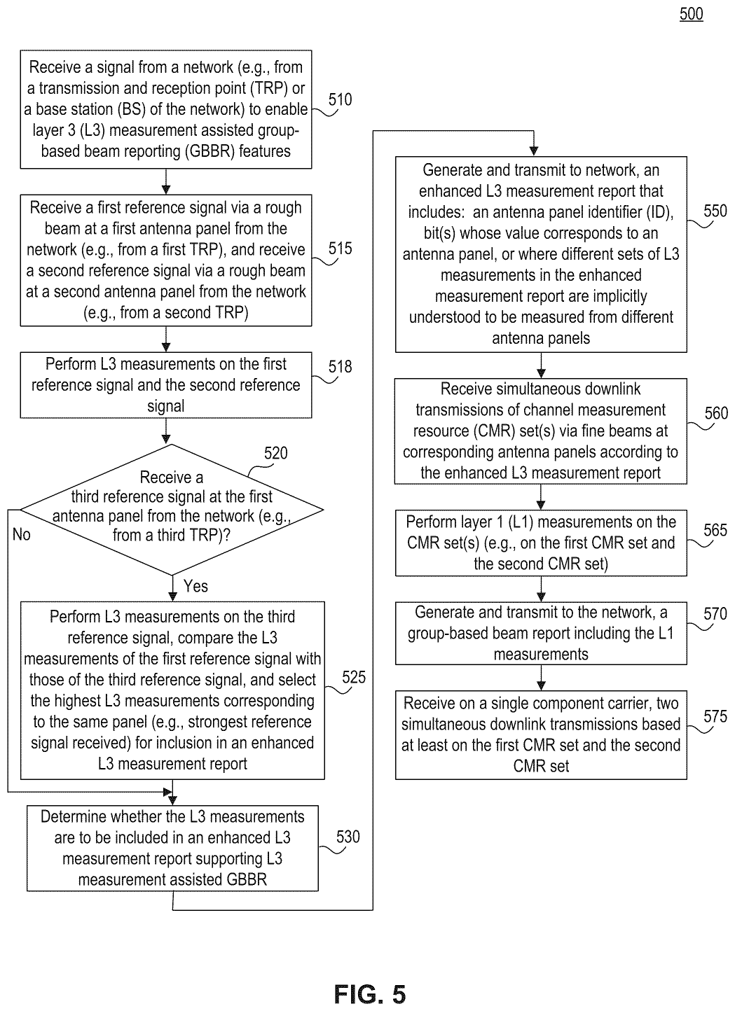

FIG. 5 illustrates example method 500 for a UE supporting L3 measurement assisted GBBR, according to some embodiments of the disclosure. For explanation purposes and not a limitation, FIG. 5 may be described with reference to elements from FIGS within the disclosure. For example, method 500 can be performed by UE 105 of FIG. 1, system 200 of FIG. 2, UE 305 of FIG. 3, and/or UE 405 of FIG. 4. For example and not a limitation, method 500 is described as being performed by UE 405 and/or UE 305. Further, a UE can receive signals from a TRP that communicates with a BBU and/or a BS (not shown) that can include functions of a TRP and a BBU.

At 510, UE 405 can receive a signal from a network (e.g., from a TRP or a BS of network 420) to enable L3 measurement assisted GBBR features. For example, UE 405 can receive first reference signals from network 420 via rough beam 421a, and perform first L3 measurements on the received reference signals. UE 405 can also receive second reference signals from network 420 at a different AoA via rough beam 421b, and perform second L3 measurements on the received reference signals. UE 405 can transmit an enhanced L3 measurement report to network 420 (e.g., via a TRP or a BS) that includes first L3 measurements and second L3 measurements. The first L3 measurements include corresponding panel 1 440 information and the second L3 measurements include corresponding panel 2 445 information with an explicit antenna panel ID, implicitly, or via bits that indicate the measurements correspond to different antenna panels. Network 420 uses the enhanced L3 measurement report to generate and transmit refined CMR sets corresponding to the different AoAs and/or antenna panel information. UE 405 can receive the reference signals in the corresponding CMR sets at the respective antenna panels simultaneously via fine beams. UE 405 can generate L1 measurements based on the reference signals received and transmit the L1 measurements in a report for GBBR. The signal can be an RRC signal, MAC CE signal, or a DCI signal. For example, the signal can be received from TRP1 410a or TRP2 410b. In some embodiments, UE 405 can receive a signal from network 420 to disable L3 measurement assisted GBBR features when communicating with network 420.

At 515, UE 405 can receive a first reference signal via a rough beam at a first antenna panel from the network (e.g., from a first TRP), and receive a second reference signal via a rough beam at a second antenna panel from the network (e.g., from a second TRP). For example, UE 405 can receive SSB2 (RS12 432a) at panel 1 440 and SSB K+1 (RS21 430b) at panel 2 445.

At 518, UE 405 can perform L3 measurements on the first reference signal and the second reference signal.

At 520, UE 405 determines whether a third reference signal is received at the first antenna panel from the network (e.g., from a third TRP (e.g., in FIG. 3, UE 305 can receive SSB 3K 334c received at panel 1 340.) When the third reference signal is received, method 500 proceeds to 525. Otherwise, method 500 proceeds to 530.

At 525, UE 405 can perform L3 measurements on the third reference signal, compare the L3 measurements of the first reference signal with those of the third reference signal, and select the highest L3 measurements corresponding to the same panel (e.g., strongest reference signal received) for inclusion in an enhanced L3 measurement report. For example, UE 305 can compare a first reference signal from TRP1 310a and a third reference signal from TRP3 310c, and based on the L3 measurements, select reception from TRP1 310a.

At 530, UE 405 can determine whether the L3 measurements are to be included in an enhanced L3 measurement report supporting L3 measurement assisted GBBR. For example, UE 405 can compare L3 measurements made based on the second reference signal received from TRP2 410b against threshold values to determine whether to receive DL transmissions from TRP2 410b. Although a comparison of L3 measurements from TRP2 410b are mentioned, note that UEs can compare the L3 measurements of any reference signals against threshold values to determine whether the received reference signals are strong enough to warrant further reception from that direction.

At 550, UE 405 can generate and transmit to network, an enhanced L3 measurement report where the L3 measurements can include: an antenna panel identifier (ID), bit(s) whose value corresponds to an antenna panel, or where different sets of L3 measurements in the enhanced measurement report are implicitly understood to be measured from different antenna panels. For example, the first L3 measurements can include an antenna panel ID (e.g., (RSRP/RSRQ/RS-SINR, 1), where ‘1’ identifies a specific antenna panel (e.g., panel 1 440.) The second L3 measurements can include (RSRP/RSRQ/RS-SINR, 2), where the value of ‘2’ indicates panel 2 445. In another example, the first L3 measurement report can include a bit value corresponding to an antenna panel (e.g., (RSRP/RSRQ/RS-SINR, 0) where a bit value (e.g., ‘0’) refers to an antenna panel of UE 405, while bit value ‘1’ corresponds to a different antenna panel of UE 405. In another example, the presence of different L3 measurements in the enhanced L3 measurement report implies that the first L3 measurements correspond to a different antenna panel than the second L3 measurements.

At 560, UE 405 can receive simultaneous downlink transmissions of CMR set(s) via fine beams at corresponding antenna panels according to the enhanced L3 measurement report.

At 565, UE 405 can perform L1 measurements on the reference signals of the CMR set(s) (e.g., on the first CMR set and the second CMR set.)

At 570, UE 405 can generate and transmit to the network, a group-based beam report including the L1 measurements measured at 565.

At 575, UE 405 can receive on a single component carrier, second simultaneous downlink transmissions (e.g., another two simultaneous downlink transmissions) based at least on the first CMR set and the second CMR set. For example, network 420 can transmit simultaneous downlink transmissions (e.g., via TRP1 410a, TRP2 410b, and/or one or more BSs) based at least on the report for GBBR, to UE 405. In some embodiments, the simultaneous downlink transmissions include different payloads.

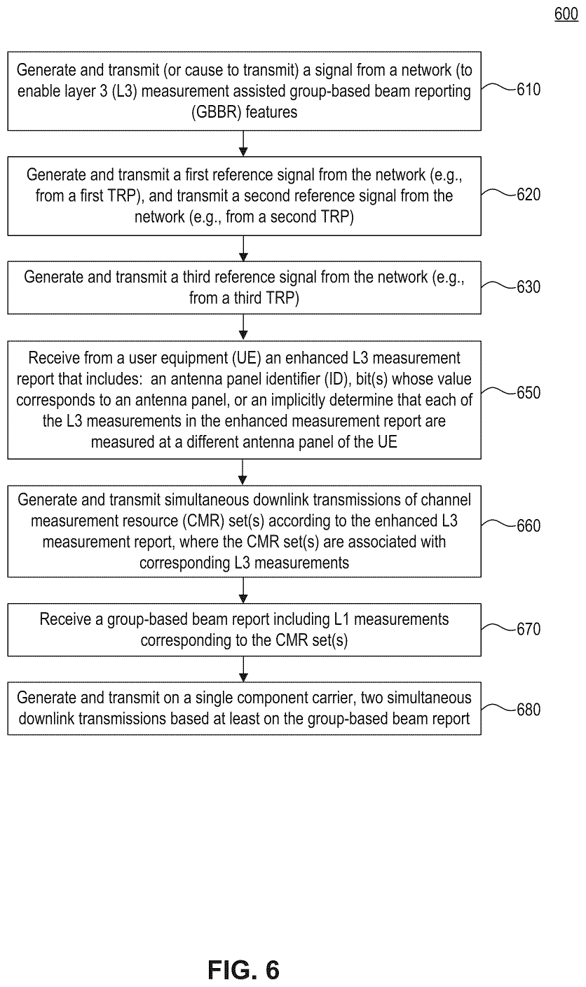

FIG. 6 illustrates example method 600 for a network (e.g., a network BBU and/or a BS) supporting L3 measurement assisted GBBR, according to some embodiments of the disclosure. For explanation purposes and not a limitation, FIG. 6 may be described with reference to elements from FIGS within the disclosure. For example, method 600 can be performed by elements of network 120 or network 420 such as network BBU 125 of FIG. 1, system 200 of FIG. 2, and/or network BBU 425 of FIG. 4, or a BS (not shown) that includes the functions of a TRP and a network BBU. For example and not a limitation, method 600 is described as being performed by network BBU 425.

At 610, network 420 can generate and transmit (or cause to transmit) a signal from a network (to enable L3 measurement assisted GBBR features. For example, network BBU 425 can transmit a signal from network 420 (e.g., via one or more TRPs of network 420) to enable or disable L3 measurement assisted GBBR features. The signal can be an RRC signal, MAC CE signal, or a DCI signal.

At 620, network 420 can generate and transmit (or cause to transmit) a first reference signal from the network (e.g., from a first TRP), and transmit a second reference signal from the network (e.g., from a second TRP). For example, network BBU 425 can transmit a first reference signal via TRP1 410a and a second reference signal via TRP2 410b.

At 630, network 420 can generate and transmit (or cause to transmit) a third reference signal from network 420 (e.g., from a third TRP.) For example, network BBU 25 can transmit a third reference signal via a third TRP (not shown) of the one or more TRPs of network 420.

At 650, network 420 can receive from UE 405 an enhanced L3 measurement report with L3 measurements that include: an antenna panel identifier (ID), bit(s) whose value corresponds to an antenna panel, or an implicitly determine that each of the L3 measurements in the enhanced measurement report are measured at a different antenna panel of UE 405.

At 660, network 420 can generate and transmit (or cause to transmit) simultaneous downlink transmissions of CMR set(s) according to the enhanced L3 measurement report, where the CMR set(s) are associated with corresponding L3 measurements of the enhanced L3 measurement report.

At 670, network 420 can receive a group-based beam report including L1 measurements corresponding to the CMR set(s).

At 680, network 420 can generate and transmit (or cause to transmit) on a single component carrier, second simultaneous downlink transmissions based at least on the group-based beam report. For example, network BBU 425 can cause the transmission of simultaneous downlink transmissions (e.g., via TRP1 410a, TRP2 410b, and/or one or more BSs) to UE 405 based at least on the report for GBBR. In some embodiments, the simultaneous downlink transmissions include different payload.

Some embodiments include BS 427 of network 420 that can transmit a first reference signal at a first AoA, and receive from a UE, an enhanced L3 measurement report including L3 measurements corresponding to the first reference signal, and second L3 measurements corresponding to a second reference signal transmitted at a second AoA. The BS can transmit a first downlink transmission associated with the first L3 measurements. In some examples, the first AoA corresponds to a different QCL D reference signal than the second AoA. The first downlink transmission can include a first CMR set generated based on the first L3 measurements. The BS can receive a group-based beam report including layer 1 measurements that are based at least on the first CMR set, and transmit a second downlink transmission based at least on the group-based beam report. In some examples, first L3 measurements include an antenna panel identity (ID), N, where N is an integer that corresponds to an antenna panel of the UE associated with the first L3 measurements. In some examples, first L3 measurements includes one or more bits, where the value of the one or more bits corresponds to an antenna panel of the UE associated with the first L3 measurements.

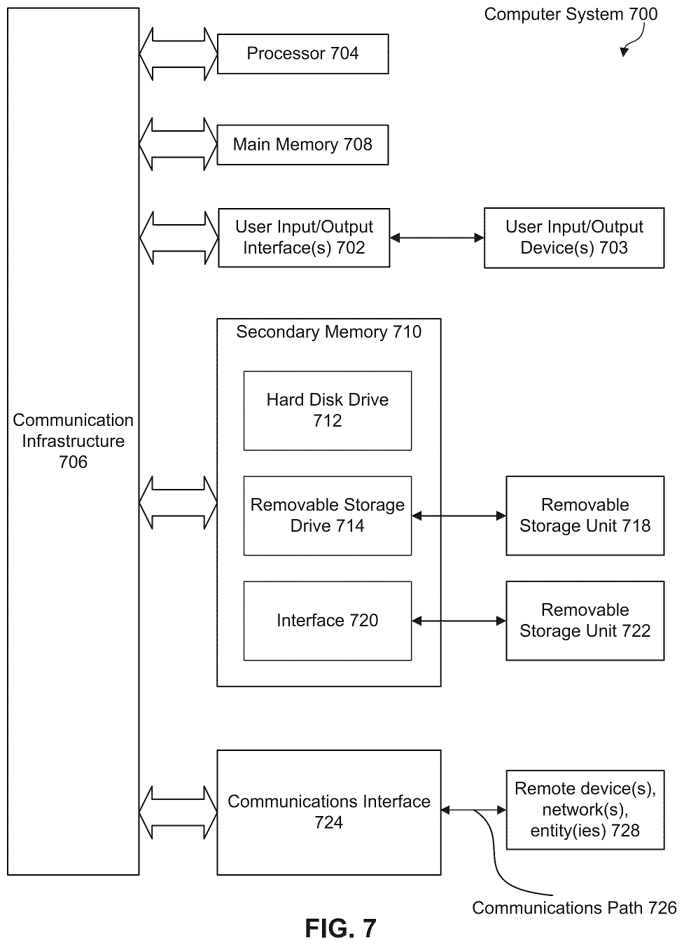

Various embodiments can be implemented, for example, using one or more well-known computer systems, such as computer system 700 shown in FIG. 7. Computer system 700 can be any well-known computer capable of performing the functions described herein. For example, and without limitation, UE 105, BBU 125, BS 127 including TRP and BBU 125 functions, TRP1 110a, TRP2 110b, TRP3 110c of FIG. 1, UE 305, TRP1 310a, TRP2 310b, TRP3 310c of FIG. 3, UE 405, BBU 425, BS 427 including TRP and BBU 425 functions, TRP1 410a, TRP2 410b, TRP3 410c of FIG. 4, method 500 of FIG. 5, and method 600 of FIG. 6, (and/or other apparatuses and/or components shown in the figures) may be implemented using computer system 700, or portions thereof.

Computer system 700 includes one or more processors (also called central processing units, or CPUs), such as a processor 704. Processor 704 is connected to a communication infrastructure 706 that can be a bus. One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to some embodiments, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LAN, WANs, the Internet, etc. Control logic and/or data may be transmitted to and from computer system 700 via communication path 726.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 7. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a memory; and
a processor communicatively coupled to the memory, configured to:
receive a first reference signal from a network at a first angle of arrival (AoA);
receive a second reference signal from the network at a second AoA;
perform layer 3 (L3) measurements on the first reference signal and the second reference signal, resulting in corresponding first L3 measurements and second L3 measurements;
generate and transmit to the network, an enhanced L3 measurement report comprising the first L3 measurements corresponding to the first reference signal and the second L3 measurements corresponding to the second reference signal; and
receive simultaneous downlink transmissions from the network that are based on the enhanced L3 measurement report.

2. The UE of claim 1, wherein a downlink transmission of the simultaneous downlink transmissions correspond to a different Quasi-Colocation (QCL) D reference signal than other downlink transmissions of the simultaneous downlink transmissions.

3. The UE of claim 1, wherein to receive the simultaneous downlink transmissions, the processor is configured to:
receive, via a first antenna panel coupled to the processor, a first channel measurement resource (CMR) set based on the first L3 measurements; and
receive simultaneously, via a second antenna panel coupled to the processor, a second CMR set based on the second L3 measurements.

4. The UE of claim 3, wherein the processor is further configured to:
perform layer 1 (L1) measurements on the first CMR set and the second CMR set; and
generate and transmit to the network, a group-based beam report including the layer 1 measurements.

5. The UE of claim 4, wherein the processor is further configured to receive on a single component carrier, second simultaneous downlink transmissions based at least on the first CMR set and the second CMR set, wherein the second simultaneous downlink transmissions comprise different payloads.

6. The UE of claim 1, wherein the first L3 measurements comprise an antenna panel identity (ID), N, wherein N is an integer corresponding to a first antenna panel of a plurality of antenna panels of the UE that received the first reference signal.

7. The UE of claim 1, wherein the first L3 measurements comprise a bit, wherein a value of the bit corresponds to a first antenna panel of the UE that receives the first reference signal.

8. The UE of claim 1, wherein a presence of the first L3 measurements and the second L3 measurements in the enhanced L3 measurement report implies that the first L3 measurements and the second L3 measurements are measured at different antenna panels of the UE.

9. A network baseband unit (BBU) comprising:
a memory; and
a processor communicatively coupled to the memory, configured to:
transmit, or cause to transmit, a first reference signal at a first angle of arrival (AoA);
transmit, or cause to transmit, a second reference signal at a second AoA;
receive from a user equipment (UE), an enhanced layer 3 (L3) measurement report comprising L3 measurements corresponding to the first reference signal, and second L3 measurements corresponding to the second reference signal; and
transmit, or cause to transmit, simultaneously, a first downlink transmission associated with the first L3 measurements, and a second downlink transmission associated with the second L3 measurements.

10. The network BBU of claim 9, wherein the first downlink transmission corresponds to a different Quasi-Colocation (QCL) D reference signal (RS) than the second downlink transmission.

11. The network BBU of claim 9, wherein the processor is further configured to:
select and transmit or cause to transmit a first channel measurement resource (CMR) set based on the first L3 measurements; and
select and transmit or cause to transmit a second CMR set based on the second L3 measurements.

12. The network BBU of claim 11, wherein the processor is further configured to:
receive a group-based beam report including layer 1 measurements, wherein the layer 1 measurements are based at least on the first CMR set and the second CMR set; and
transmit simultaneously on a single component carrier, the first downlink transmission based at least on the first CMR set and the second downlink transmission based at least on the second CMR set.

13. The network BBU of claim 9, wherein the first L3 measurements comprise an antenna panel identity (ID), N, where N is an integer, wherein N corresponds to an antenna panel of the UE associated with the first L3 measurements.

14. The network BBU of claim 9, wherein the first L3 measurements comprises one or more bits, wherein a value of the one or more bits corresponds to an antenna panel of the UE associated with the first L3 measurements.

15. The network BBU of claim 9, wherein the processor is further configured to: transmit a signal for enabling or disabling enhanced L3 measurement reporting that supports L3 measurement assisted group-based beam reporting (GBBR).

16. A method for a user equipment (UE) comprising:
receiving a first reference signal from a network at a first angle of arrival (AoA);
receiving a second reference signal from the network at a second AoA;
performing layer 3 (L3) measurements on the first reference signal and the second reference signal, resulting in corresponding first L3 measurements and second L3 measurements;
generating and transmitting to the network, an enhanced L3 measurement report comprising the first L3 measurements corresponding to the first reference signal and the second L3 measurements corresponding to the second reference signal; and
receiving simultaneous downlink transmissions from the network that are based on the enhanced L3 measurement report.

17. The method of claim 16, wherein the first L3 measurements comprise an antenna panel identity (ID), N, wherein N is an integer corresponding to a first antenna panel of a plurality of antenna panels of the UE that received the first reference signal, or wherein the first L3 measurements comprise a bit, wherein a value of the bit corresponds to a first antenna panel of the UE that receives the first reference signal.

18. The method of claim 16, wherein a presence of the first L3 measurements and the second L3 measurements in the enhanced L3 measurement report implies that the first L3 measurements and the second L3 measurements are measured at different antenna panels of the UE.

19. The method of claim 16, further comprising:
receiving a third reference signal from the network at a third AoA, wherein the first reference signal and the third reference signal are received on a same antenna panel; and
comparing L3 measurements of the first reference signal with L3 measurements of the third reference signal, wherein the first L3 measurements are based at least on the comparison.

20. The method of claim 16, wherein the first reference signal is received via a rough beam, and wherein a downlink transmission of the simultaneous downlink transmissions is received via a fine beam.
